(19) United States
(12) Patent Application Publication
(10) Pub. No.: US 2026/0021667 A1
(43) Pub. Date: Jan. 22, 2026

(54) PLATEN FOR INKJET PRINTER

(71) Applicant: BROTHER KOGYO KABUSHIKI KAISHA, Nagoya (JP)

(72) Inventors: Sho MISHIMA, Okazaki (JP); Hidekazu KOMIYA, Okazaki (JP); Kazuhisa TASHIMA, Okazaki (JP); Chisato INOUE, Okazaki (JP); Marina MATSUYAMA, Okazaki (JP); Hidetoshi SAWADA, Okazaki (JP)

(21) Appl. No.: 19/340,118

(22) Filed: Sep. 25, 2025

Related U.S. Application Data
(63) Continuation of application No. PCT/JP2023/046112, filed on Dec. 22, 2023.

(30) Foreign Application Priority Data
Mar. 31, 2023 (JP) 2023-057270

(51) Int. Cl. B41J 11/06; B41J 3/407; B41J 11/20

(52) U.S. Cl. CPC B41J 11/06; B41J 3/40731; B41J 3/4078; B41J 11/20

(57) ABSTRACT

A platen for an inkjet printer configured to support at least a part of a printing medium to be printed by an inkjet printer, the platen includes: a base platen configured to support at least a part of the printing medium and includes a surface extending in a first direction and a second direction orthogonal to the first direction; a sub-platen disposed on an upper portion of at least one of an end portion in the first direction and an end portion in the second direction of the surface; and a protrusion protruding from the sub-platen and configured to press the printing medium supported by the surface.

### REFERENCE TO RELATED APPLICATIONS

This is a continuation application of International Application No. PCT/JP2023/046112 filed on Dec. 22, 2023, which claims priority from Japanese Patent Application No. 2023-057270 filed on Mar. 31, 2023. The entire contents of the aforementioned applications are incorporated herein by reference.

### BACKGROUND ART

A printing medium of an inkjet printer includes clothing including a cap. For example, a related art discloses a presser bar that is used in an inkjet printer and presses a printing region (print receiving portion) of clothing. In the platen, a cap is supported by an upper surface of a rigid base plate. In this support state, an upper side of a brim portion (front portion or visor in the same Patent Literature) of the cap is pressed by the presser bar across the upper side.

Since the presser bar disclosed in the related art across the upper side of the brim portion, printing cannot be performed at a position of the presser bar.

### SUMMARY

The present disclosure has been made to solve such a problem, and an object of the present disclosure is to provide a platen that reduces a region where printing cannot be performed.

In order to solve the above problem, a platen for an inkjet printer according to the present disclosure is a platen configured to support at least a part of a printing medium to be printed by an inkjet printer, the platen includes: a base platen that supports at least a part of the printing medium and has a surface extending in a first direction and a second direction orthogonal to the first direction; a sub-platen disposed on an upper portion of at least one of an end portion in the first direction and an end portion in the second direction of the surface; and a protrusion protruding from the sub-platen and configured to press the printing medium supported by the surface.

### BRIEF DESCRIPTION OF THE DRAWINGS

FIG. 1 is a perspective view illustrating a representative configuration example of an inkjet printer and a platen.

FIG. 2 is a perspective view illustrating a configuration example in which a sub-platen is closed in the platen illustrated in FIG. 1.

FIG. 3 is a perspective view illustrating a configuration example in which the sub-platen is opened in the platen illustrated in FIG. 1.

FIGS. 4A to 4D are diagrams illustrating an operation example of a locker provided in the platen illustrated in FIG. 1.

FIG. 5 shows a plan view, a cross-sectional view, and a bottom view schematically illustrating a configuration example of a tab serving as a protrusion provided in the platen illustrated in FIG. 1.

FIG. 6 is a schematic perspective view illustrating an example of a state in which a brim portion of a cap that is a printing medium is supported by the platen illustrated in FIG. 1.

FIG. 7 is a perspective view illustrating another configuration example of the tab serving as the protrusion portion of the present disclosure.

FIG. 8 is a perspective view illustrating another configuration example of the locker of the present disclosure.

### DESCRIPTION

Hereinafter, a representative embodiment of the present disclosure will be described with reference to the drawings. In the following description, the same or corresponding elements are denoted by the same reference numerals in all the drawings, and redundant description thereof is omitted.

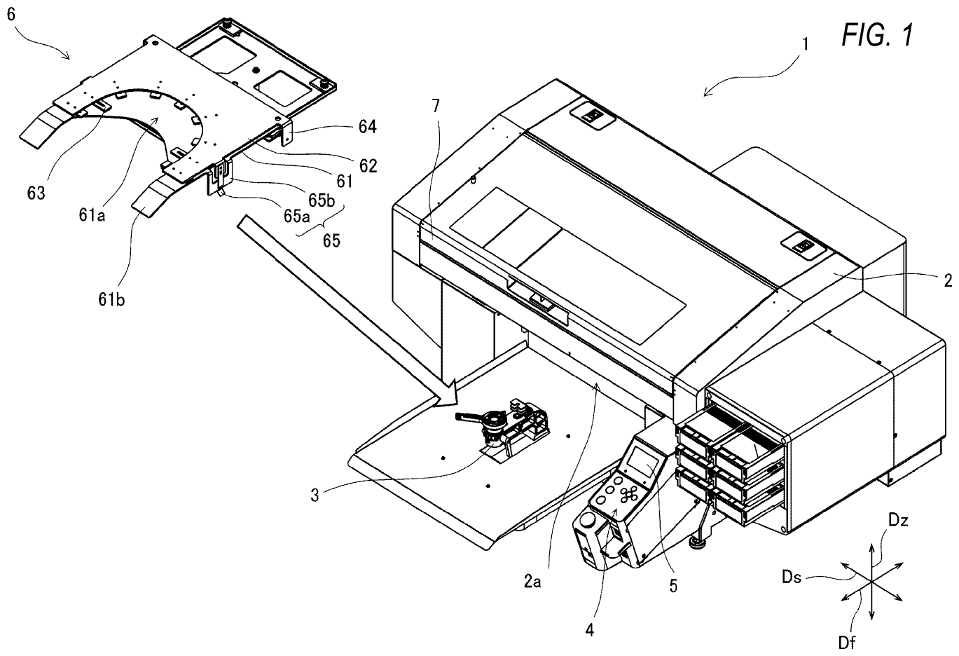

FIG. 1 is a perspective view illustrating an inkjet printer 1 according to an embodiment of the present disclosure. In FIG. 1, directions orthogonal to one another are defined as a first direction Ds, a second direction Df, and a third direction Dz. In the present embodiment, for example, the first direction Ds is a movement direction of a carriage to be described later. The second direction Df is a conveyance direction of a printing medium to be described later and is also a front-rear direction. The third direction Dz is an up-down direction. For convenience of description, “front” of the inkjet printer 1 is referred to as one end in the second direction Df, “rear” thereof is referred to as the other end in the second direction Df, “up” thereof is referred to as one end in the third direction Dz, and “down” thereof is referred to as the other end in the third direction Dz. In addition, one end in the first direction Ds when viewed from the “front” is referred to as “right”, and the other end in the first direction Ds is referred to as “left”.

As illustrated in FIG. 1, the inkjet printer 1 of the present embodiment includes a housing 2, a platen fixing portion 3, operation keys 4, a display unit 5, a platen 6, an upper cover 7, and the like. The housing 2 includes a discharge head, a carriage, a guide rail, a storage tank, and a controller unit including a controller.

The housing 2 is formed in a box shape. The housing 2 has an opening 2a. The housing 2 is provided with the operation keys 4. In addition, the display unit 5 is provided near the operation keys 4. The operation keys 4 receive operations input by a user. The display unit 5 is configured by, for example, a touch panel and displays predetermined information. A part of the display unit 5 may function as an operation key.

The upper cover 7 is configured to pivot upward and open when an end portion thereof is lifted. Thus, an inside of the housing 2 is exposed. Although not illustrated, as described above, a storage tank, a discharge head, a carriage, a pair of guide rails, and the like are disposed in the housing 2.

The discharge head is mounted on the carriage and has a nozzle surface. The nozzle surface has, for example, a plurality of nozzle rows arranged in parallel in the first direction Ds. The pair of guide rails extend along the first direction Ds. The carriage is supported by the pair of guide rails. Accordingly, the carriage and the discharge head reciprocate in the first direction Ds. The discharge head is connected to the storage tank via a tube. Ink is stored in the storage tank.

The discharge head forms a color image by ejecting ink droplets of a plurality of colors onto the printing medium supported by the platen 6. In the present embodiment, for example, ink of each color of yellow, magenta, cyan, black, white, and clear is used. The storage tank is provided for each type of ink.

The controller unit causes the inkjet printer 1 to perform a printing operation based on an input from the operation keys 4 or an external input via another communication interface, and controls display of the display unit 5.

A specific configuration of the inkjet printer 1 in the present disclosure is not limited to the above-described configuration illustrated in FIG. 1. In the present disclosure, various known inkjet printing devices or image forming devices are applicable.

The platen 6 supports the printing medium such that printing can be performed by the inkjet printer 1. As illustrated in FIG. 1, the platen 6 is detachably fixed to the inkjet printer 1 by the platen fixing portion 3. A specific configuration of the platen fixing portion 3 is not particularly limited, and a known configuration can be suitably used.

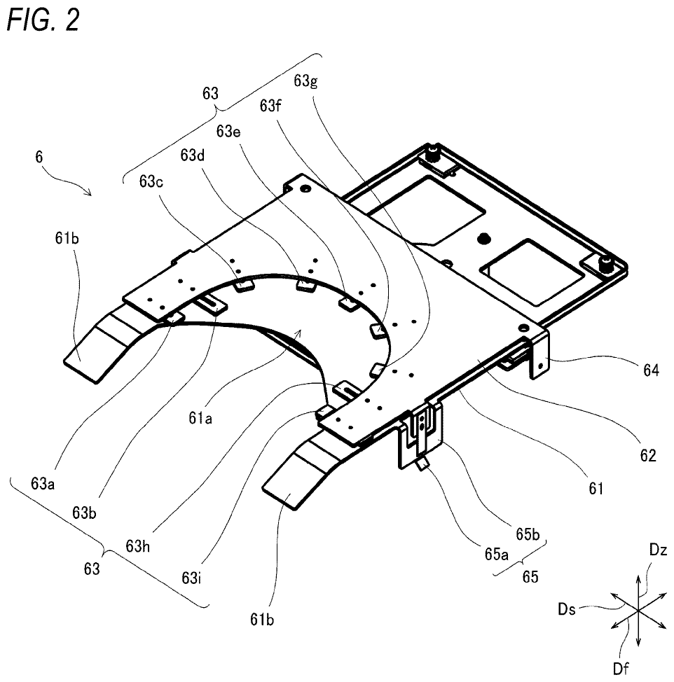

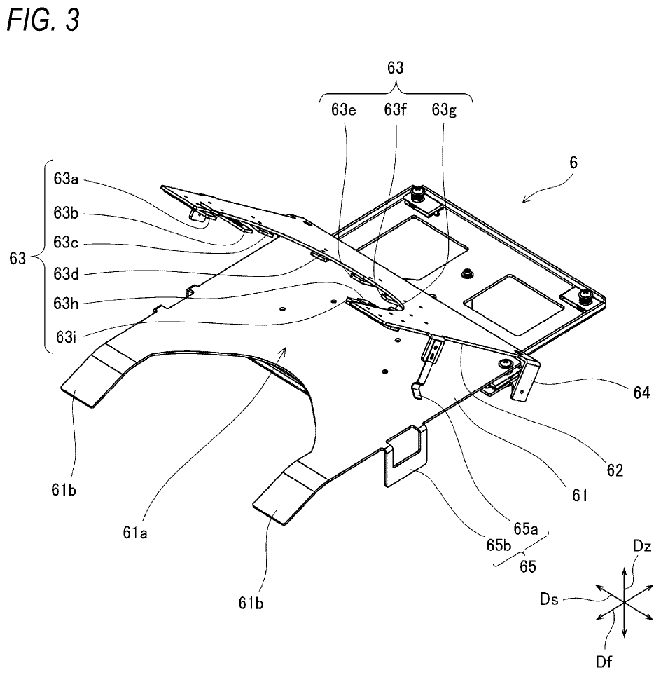

FIGS. 2 and 3 are perspective views illustrating the platen 6 according to the embodiment of the present disclosure. In the present embodiment, as illustrated in FIGS. 2 and 3, the platen 6 includes a base platen 61 and a sub-platen 62. The base platen 61 has a support surface 61a that supports at least a part of the printing medium and extends in the first direction Ds (left-right direction) and the second direction Df (front-rear direction). The sub-platen 62 is disposed on the support surface 61a of the base platen 61.

In the present embodiment, the sub-platen 62 is disposed on an upper portion at the left, right, and rear of the support surface 61a. Therefore, in FIGS. 1 and 2, only the center and the front of the support surface 61a of the base platen 61 are exposed due to the sub-platen 62. In the present embodiment, a boundary between the sub-platen 62 and the support surface 61a when viewed from an upward direction has an arc shape.

In the present embodiment, a central portion of a front portion of the base platen 61 is largely cut out except both end portions in the left-right direction. The reason is, as will be described later, that when a cap that is a printing medium is supported by the platen 6, a brim portion (visor) of the cap is supported by the support surface 61a of the base platen 61, and a main body (crown) of the cap is disposed at a position where the center of the front portion of the base platen 61 is cut out. Therefore, in the present embodiment, the platen 6 does not need to support the entire printing medium, and may be configured to support a part of the printing medium.

In the present embodiment, portions serving as left and right end portions of the front portion of the base platen 61 are a pair of inclined portions 61b. The inclined portion 61b has a shape having a length along the front-rear direction of the base platen 61, and a tip end thereof is inclined downward.

In the present embodiment, the platen 6 includes a plurality of tabs 63 as protrusion portions protruding from the sub-platen 62 to the support surface 61a. In the examples illustrated in FIGS. 1 to 3, a total of nine tabs 63a to 63i are provided surrounding the support surface 61a. The tab 63 presses a peripheral edge portion of the printing medium supported by the support surface 61a. The tab 63 will be described later.

In the present embodiment, the platen 6 includes a hinge 64 at a rear portion as a coupling portion that couples the sub-platen 62 to the base platen 61. The sub-platen 62 is pivotably attached to the base platen 61 with the hinge 64 as a rotation shaft. Therefore, a front portion of the sub-platen 62 can be opened and closed. In FIGS. 1 and 2, since the sub-platen 62 is disposed overlapping the base platen 61, the sub-platen 62 is in a closed state. On the other hand, in FIG. 3, the sub-platen 62 is in an open state due to the hinge 64. In the present embodiment, the tab 63 serving as a protrusion portion is capable of advancing and retreating with respect to the sub-platen 62 along the support surface 61a in the closed state.

In the present embodiment, the platen 6 includes a locker 65. The locker 65 maintains the closed state of the sub-platen 62. A specific configuration and the number of the locker 65 are not particularly limited, but in the present embodiment, the locker 65 is constituted by a hook 65a provided in the sub-platen 62 and a frame body 65b provided in the base platen 61.

In the present embodiment, the hook 65a is integrally provided near a center of a right side portion (one end in first direction Ds) of the sub-platen 62, has a length downward in the up-down direction (third direction Dz), and has a curved portion at a lower end. The frame body 65b is integrally provided at a position corresponding to the hook 65a on a right side portion (one end in first direction Ds) of the base platen 61 in the left-right direction, has a length downward in the up-down direction (third direction Dz), and has a shape formed with a hollow.

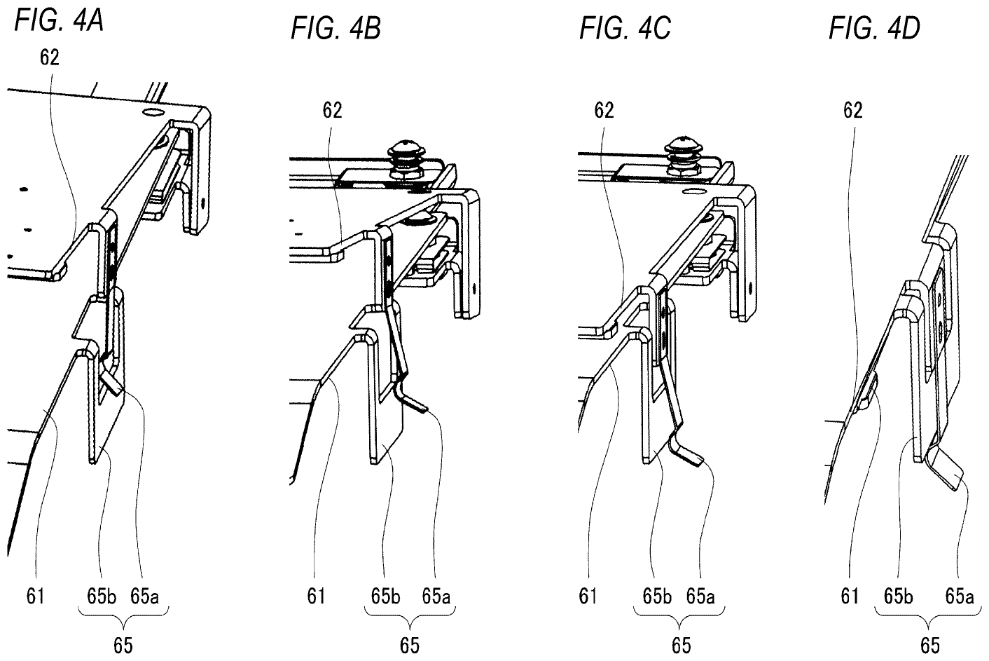

FIGS. 4A to 4D are diagram illustrating an operation example of the locker 65 provided in the platen 6 illustrated in FIGS. 1 to 3. The operation example is illustrated by an enlarged perspective view of the vicinity of the locker 65 in the platen 6. As illustrated in FIG. 3, when the sub-platen 62 is in the open state, the right side portion of the base platen 61 and the right side portion of the sub-platen 62 are separated from each other. Therefore, in FIG. 3, the hook 65a and the frame body 65b are sufficiently separated from each other.

When the sub-platen 62 is gradually closed, the right side portion of the sub-platen 62 approaches the right side portion of the base platen 61. As illustrated in FIGS. 4A to 4D, for example, the curved portion at a tip end of the hook 65a extends in a downward direction and is curved leftward. Accordingly, when the right side portion of the base platen 61 approaches, the curved portion is located in the hollow of the frame body 65b and abuts on an inner edge of the hollow. When the sub-platen 62 is further closed, the hook 65a is pressed downward. Therefore, due to elasticity of the hook 65a, the curved portion curved leftward moves rightward and downward from the hollow of the frame body 65b and is located at an outer upper portion of the frame body 65b.

When the sub-platen 62 is further closed, the hook 65a is continuously pressed downward. Therefore, the curved portion at the tip end of the hook 65a moves to a lower right portion of the frame body 65b. When the sub-platen 62 is further closed to be in the closed state illustrated in FIG. 2, the curved portion at the tip end of the hook 65a that has moved rightward moves leftward due to the elasticity of the hook 65a and engages with a lower end of the frame body 65b. Accordingly, the closed state of the sub-platen 62 can be favorably maintained.

A specific configuration of the platen 6 in the present disclosure is not limited to the above-described configuration illustrated in FIGS. 1 to 4D. In the present disclosure, the platen 6 may be configured to support at least a part of the printing medium and include the base platen 61, the sub-platen 62, and the tab 63 (protrusion portion). Therefore, for example, a configuration of the hinge 64 may be a known configuration, and the hinge 64 may not be provided. The sub-platen 62 may be detachable from the base platen 61. A configuration of the locker 65 is not limited to that illustrated in FIGS. 4A to 4D, and other known fixing mechanisms or the like may be used, or the locker 65 may not be provided.

In the present embodiment, the platen 6 has the tab 63 serving as the protrusion portion as described above. The tab 63 protrudes from the sub-platen 62 and presses a part of the printing medium supported by the support surface 61a. In the present disclosure, at least one tab 63 may be provided, or a plurality of tabs 63 may be provided. In the embodiment, as illustrated in FIGS. 1 to 3, nine protrusion portions of the tabs 63a to 63i are provided, but the present disclosure is not limited thereto. By including the plurality of tabs 63, the printing region can be more favorably supported.

In the present embodiment, the tabs 63b to 63i are disposed so as to surround the support surface 61a clockwise with reference to the tab 63a located in front of the left (the other end in first direction Ds) of the platen 6 (second direction Df).

In the present embodiment, each of the tabs 63a to 63i is configured to be capable of advancing and retreating with respect to the sub-platen 62 along the support surface 61a. As long as the tabs 63a to 63i are capable of advancing and retreating, the printing medium can be pressed within a range of advance and retreat even when a size of the printing medium is different. Accordingly, even a printing medium of a different size can be favorably supported.

In the present embodiment, each of the tabs 63a to 63i are capable of advancing and retreating independently of each other. Accordingly, even when a shape of the printing medium is different from a shape of the support surface 61a, the printing medium can be favorably pressed. Accordingly, the printing medium can be more stably supported. A representative configuration example in which the tabs 63a to 63i are caused to advance and retreat will be described later.

In the present embodiment, each of the tabs 63a to 63i is configured as a rectangular plate-shaped member having a step. Each of the tab 63a, the tab 63b, the tab 63h, and the tab 63i protrudes in the first direction Ds, and the tab 63e protrudes in the second direction Df. Each of the tab 63c, the tab 63d, the tab 63f, and the tab 63g protrudes in a direction (inclination direction) inclined with respect to the first direction Ds and the second direction Df.

In the present embodiment, each dimension of the tabs 63a to 63i in the first direction Ds and the second direction Df is larger than a dimension in the third direction Dz. Accordingly, it is possible to reduce a distance between the printing medium supported by the base platen 61 and the nozzle surface of the discharge head provided in the inkjet printer 1. Accordingly, printing quality can be improved. A more specific configuration of the tabs 63a to 63i will be described later.

In the present embodiment, for example, when the tab 63a is defined as a first protrusion portion, any of the tabs 63b to 63i can be defined as a second protrusion portion. In this manner, by including the plurality of protrusion portions, the printing region of the printing medium can be more favorably supported.

The tabs 63a, 63b, 63h, and 63i protrude in the first direction Ds, and the tab 63c protrudes in the second direction Df. In this manner, by providing the plurality of protrusion portions protruding in directions orthogonal to each other, the printing medium can be more favorably supported. Since the first protrusion portion (tabs 63a, 63b, 63h, and 63i) and the second protrusion portion (tab 63c) can protrude in the first direction and the second direction, respectively, a range of an applicable size of the printing medium can be further widened.

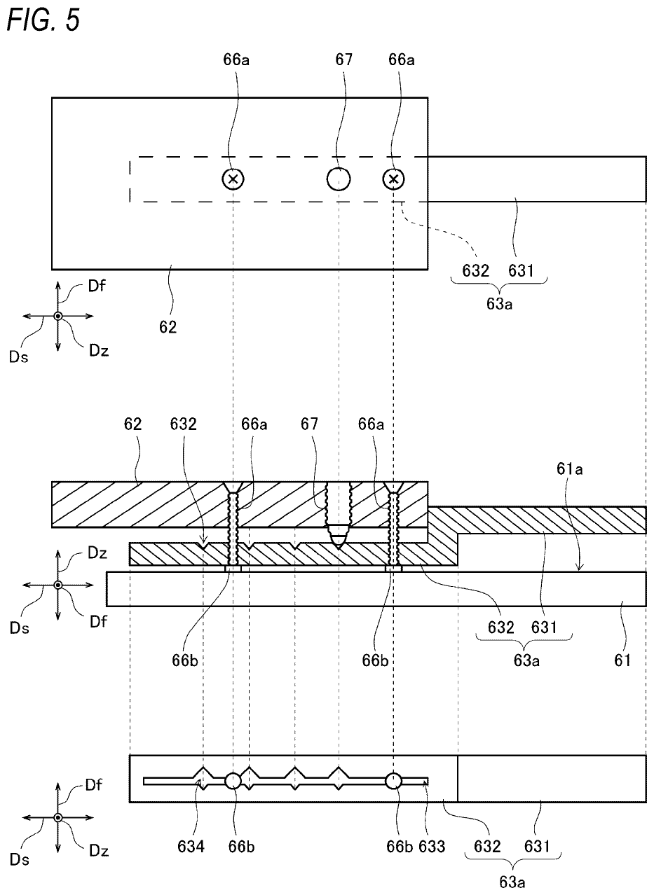

In the present disclosure, a specific configuration for causing the tab 63a to advance and retreat is not particularly limited, and a configuration example illustrated in FIG. 5 can be representatively exemplified. An upper view in FIG. 5 is a plan view illustrating a schematic configuration of the tab 63a, a middle view in FIG. 5 is a cross-sectional view illustrating a schematic configuration of the tab 63a, and a lower view in FIG. 5 is a bottom view illustrating a schematic configuration of the tab 63a. FIG. 5 illustrates the tab 63, and the tabs 63b to 63i have the same configuration.

In the present embodiment, the tab 63a has a front portion 631 and a rear portion 632. The front portion 631 is a portion that advances to the support surface 61a of the base platen 61. The rear portion 632 is a portion on an opposite side in a longitudinal direction when viewed from the front portion 631, and at least a part of the rear portion 632 is located between the base platen 61 and the sub-platen 62. In the upper view in FIG. 5, the entire rear portion 632 is located between the base platen 61 and the sub-platen 62, and thus is indicated by a broken line. A step is provided in the up-down direction at a coupling portion between the front portion 631 and the rear portion 632.

As illustrated in FIG. 5, the front portion 631 is located separated from the support surface 61a. A specific interval between a lower surface of the front portion 631 and the support surface 61a is not particularly limited. The interval can be appropriately set according to the printing medium to be supported. In addition, lengths of the front portion 631 and the rear portion 632 or a ratio of the lengths of the front portion 631 and the rear portion 632 in the tab 63a is not particularly limited. The length of the front portion 631 or the rear portion 632 and the ratio of the lengths of the front portion 631 and the rear portion 632 can be appropriately set according to a shape of the printing medium pressed by the front portion 631 or a shape of the printing region, or a difference in shape or dimension of the printing medium.

When the tab 63a has such a configuration, it is possible to ensure an interval for pressing the printing medium between the front portion 631 and the support surface 61a. Accordingly, the interval between the base platen 61 and the sub-platen 62 can be prevented from being increased. As a result, the distance between the printing medium supported by the base platen 61 and the nozzle surface of the discharge head of the inkjet printer I can also be prevented from being increased. Therefore, deterioration in printing quality can be favorably prevented. In addition, since the tab 63a has a step, a possibility that the entire tab 63a enters between the base platen 61 and the sub-platen 62 can be avoided.

In the present embodiment, a maintaining member that maintains the interval between the base platen 61 and the sub-platen 62 may be further provided. In the example illustrated in the middle view in FIG. 5, two slide guide pins 66a and nuts 66b function as the maintaining member. The maintaining member is not limited to the slide guide pins 66a and the nuts 66b, and may have another known configuration.

The slide guide pin 66a penetrates through the sub-platen 62 and the rear portion 632 of the tab 63a from an upper surface of the sub-platen 62 toward the support surface 61a of the base platen 61. The slide guide pin 66a is fastened by the nut 66b on a lower surface of the rear portion 632. Thus, the sub-platen 62 and the tab 63a are integrated.

Since the platen 6 includes the maintaining member, a predetermined interval in the up-down direction can be maintained by the maintaining member, between the base platen 61 and the sub-platen 62 which can be opened and closed in the front side. As a result, the peripheral edge portion of the printing medium supported by the support surface 61a is pressed by the tab 63 which ensures the predetermined interval. Therefore, the printing medium can be favorably supported on the support surface 61a.

In the present embodiment, the slide guide pin 66a and the nut 66b also function as guides when the tab 63a advances and retreats in the left-right direction. As illustrated in the lower view in FIG. 5, a guide slit 633 is formed in the rear portion 632 along a longitudinal direction of the rear portion 632. The slide guide pin 66a penetrates through the guide slit 633, and a tip end thereof is fastened by the nut 66b. A degree of fastening of the nut 66b in this case may be such that the advance and retreat of the tab 63a is not hindered. As an example, it is possible to give an appropriate resistance feeling when the user advances and retreats the tab 63a.

The guide slit 633 is provided in the rear portion 632 of the tab 63a, and the two slide guide pins 66a penetrate through the guide slit 633, so that the tab 63a can be caused to advance and retreat along the guide slit 633. As a result, since it is possible to prevent an advancing and retreating direction of the tab 63a from deviating from a desired advancing and retreating position, it is possible to favorably support the printing medium on the support surface 61a.

In the present embodiment, the platen 6 may include an engagement portion extending from the sub-platen 62 toward the tab 63a. In the examples illustrated in the upper and middle views of FIG. 5, a ball plunger 67 is provided. Similarly to the slide guide pin 66a, the ball plunger 67 is disposed from the upper surface of the sub-platen 62 toward the base platen 61 and abuts on an upper surface of the rear portion 632. The rear portion 632 is provided with a plurality of ball plunger slits 634 at equal intervals along the guide slit 633. In the example illustrated in the lower view in FIG. 5, there are four ball plunger slits 634.

A tip end of the ball plunger 67 abuts on and engages with the ball plunger slit 634. Therefore, the ball plunger slit 634 is an engaged portion with respect to the engagement portion. The ball plunger 67 has a configuration in which a ball portion at the tip end is movable up and down and is biased downward.

In the lower view in FIG. 5, when an interval in the front-rear direction (second direction Df) is defined as “width”, a width of the guide slit 633 is smaller than a width (diameter) of the ball portion at the tip end of the ball plunger 67. Therefore, when the tab 63a is caused to advance and retreat, if the guide slit 633 is located directly below the ball plunger 67, the ball portion at the tip end is pushed upward. On the other hand, a width of the ball plunger slit 634 is larger than the width of the guide slit 633 and is a width that allows engagement with the ball portion of the ball plunger 67. Therefore, when the ball plunger slit 634 is located directly below the ball plunger 67, the ball portion at the tip end protrudes and engages with the ball plunger slit 634. Accordingly, the tab 63a can be suitably pressed toward the support surface 61a.

Since a plurality of the ball plunger slits 634 are provided along the advancing and retreating direction (longitudinal direction of guide slit 633) of the tab 63a, the ball plunger 67 engages with only any of the ball plunger slits 634. Accordingly, the user can position the advance and retreat of the tab 63a in the advancing and retreating direction (longitudinal direction of guide slit 633) at an interval in the advancing and retreating direction (left-right direction in lower view in FIG. 5) of the tab 63a in which the ball plunger slit 634 is provided in an extending direction (left-right direction in lower view in FIG. 5) of the guide slit 633. As a result, the tab 63a can protrude with high reproducibility. Accordingly, the printing medium can be more stably pressed on the support surface 61a.

A configuration for causing the tab 63 to advance and retreat is not limited to the above-described configuration. For example, an automatic lock type advancing and retreating mechanism that is capable of advancing and retreating by releasing a lock by pressing the rear portion 632 of the tab 63 from the upper surface of the sub-platen 62 may be provided. In this case, the sub-platen 62 or the rear portion 632 may be provided with a mechanism that enables positioning in the advancing and retreating direction. For example, the rear portion of the tab 63 may include an elastically deformable slide mechanism having a protrusion or groove serving as an engagement portion, and the sub-platen 62 may include a plurality of protrusions or grooves serving as engaged portions side by side in the advancing and retreating direction of the tab 63a. In this case, when the slide mechanism is pressed from any direction, the protrusion or groove of the slide mechanism does not come into contact with the protrusion or groove of the sub-platen 62, and the tab 63 including the slide mechanism can move in the advancing and retreating direction. On the other hand, when the pressing of the slide mechanism is released, the protrusion or groove of the slide mechanism is engaged with the protrusion or groove of the sub-platen 62, and the tab 63 including the slide mechanism is positioned in the advancing and retreating direction.

In the present embodiment, the platen 6 may be made of metal. Therefore, in a schematic cross-sectional view of the middle view in FIG. 5, the sub-platen 62 and the tab 63 are hatched with metal. However, a material of the platen 6 is not limited to metal, and may be various known materials such as a resin or a composite material.

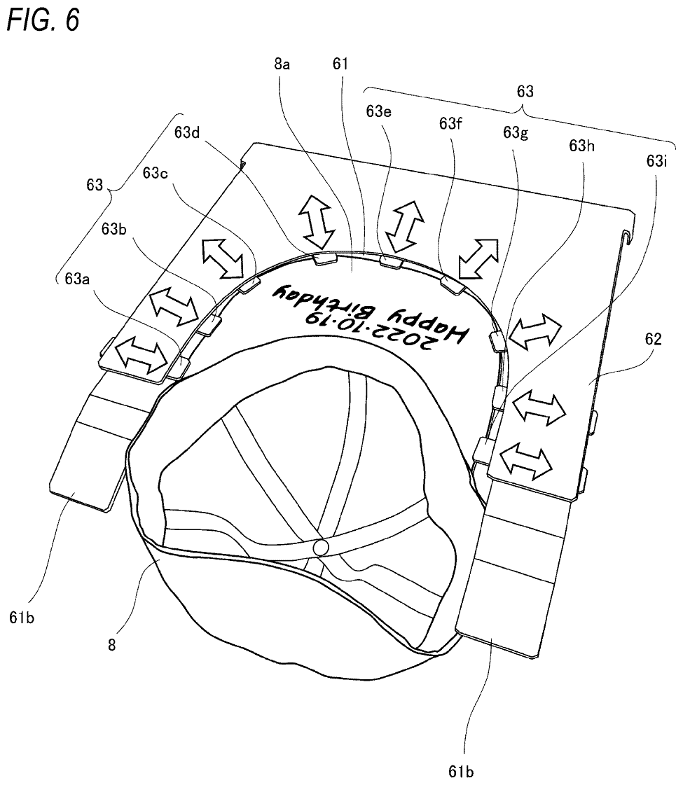

An example in which the printing medium is supported by the platen 6 of the present embodiment will be described with reference to FIG. 6. FIG. 6 is a perspective view illustrating a state in which when the printing medium is the cap 8, the cap 8 is supported by the platen 6.

In the lower view in FIG. 5, when the interval in the front-rear direction (second direction) is defined as “width”, the width of the guide slit 633 is smaller than the width (diameter) of the ball portion at the tip end of the ball plunger 67. Therefore, in the present embodiment, printing is performed on a brim portion 8a of the cap 8 by the inkjet printer 1. Generally, the brim portion 8a of the cap 8 is often curved such that a central portion is convex in design. It is difficult to perform favorable printing on a curved surface by the inkjet printer 1. Therefore, the brim portion 8a is supported by the support surface 61a of the platen 6, and a peripheral edge portion of the brim portion 8a is pressed by the tab 63. Thus, the curved brim portion 8a can be stably flattened, so that favorable printing can be performed by the inkjet printer 1.

In the present embodiment, the sub-platen 62 is pivotably attached to the base platen 61 at a rear end by the hinge 64. Therefore, as illustrated in FIG. 3, a front end of the sub-platen 62 can be opened and closed with respect to the base platen 61. Therefore, when the brim portion 8a is supported by the support surface 61a, the sub-platen 62 can be opened, and after the brim portion 8a is installed, the sub-platen 62 can be closed. Accordingly, the printing medium can be easily installed on the support surface 61a.

In the present embodiment, the pair of inclined portions 61b, which are the front ends of the base platen 61, are inclined downward. As a result, a main body of the cap 8 that is the printing medium is less likely to interfere with the front end of the base platen 61. Therefore, the brim portion 8a can be easily installed on the support surface 61a. In addition, when the cap 8 is less likely to interfere, the brim portion 8a is easily installed on the support surface 61a even when the sub-platen 62 is not largely opened. Therefore, workability is improved. Further, when the front end of the base platen 61 faces downward, a possibility that the nozzle surface of the discharge head interferes with the base platen 61 during printing can be effectively avoided.

The front end of the base platen 61 is cut out at the center to form a pair of plate-shaped inclined portions 61b at both left and right ends. Therefore, as illustrated in FIG. 6, in a state in which the brim portion 8a is supported by the support surface 61a, the main body of the cap 8 is disposed between the pair of inclined portions 61b (in cutout region). Therefore, even when the cap 8 has a three-dimensional shape, the cap 8 can be stably held by the platen 6. A bidirectional block arrow in FIG. 6 indicates an advancing and retreating direction of the tab 63.

The hook 65a and the frame body 65b as an example of the maintaining member maintain an interval between the base platen 61 and the sub-platen 62. As illustrated in FIGS. 4A to 4D, in a state in which the curved portion of the hook 65a is located in the hollow of the frame body 65b and abuts on the inner edge of the hollow, and in a state in which the curved portion of the hook 65a is engaged with the lower end of the frame body 65b, the interval between the base platen 61 and the sub-platen 62 is maintained.

Hereinafter, modifications of the present disclosure will be described. In the present embodiment, the sub-platen 62 is disposed at a portion other than the front of the support surface 61a, but the present disclosure is not limited thereto. The sub-platen 62 may be disposed only on an upper right portion of the support surface 61a, or may be disposed only on an upper left portion (the other end in first direction Ds) of the support surface 61a.

Alternatively, the sub-platen 62 may be disposed only on a front upper portion of the support surface 61a, or may be disposed on both the front upper portion and a rear upper portion of the support surface 61a. Alternatively, the sub-platen 62 may be disposed only on an upper right portion and an upper rear portion of the support surface 61a, or may be disposed only on an upper left portion and an upper rear portion of the support surface 61a. Further, in the present embodiment, a corner portion of the sub-platen 62 between the first direction Ds and the second direction Df has an arc shape (R shape), but may not have an arc shape.

The sub-platen 62 may not be configured to be openable and closable with respect to the base platen 61. For example, the sub-platen 62 may be fixed so as to overlap an upper portion of the base platen 61. In addition, the sub-platen 62 may be configured to be completely removable from the base platen 61.

The tabs 63a to 63i may not be capable of advancing and retreating with respect to the sub-platen 62, and may protrude in a fixed state. In this case, a length of the tab 63 (amount of protrusion from sub-platen 62) is not particularly limited, and may be a length that allows to press only the peripheral edge portion of the printing medium. Accordingly, since the fixed tab 63 does not press the central portion of the printing medium, a region where printing cannot be performed can be reduced.

In the present disclosure, the platen 6 may include at least one protrusion portion (tab 63 in present embodiment), but representatively, a configuration including two protrusion portions (first protrusion portion and second protrusion portion) can be exemplified. That is, in the present disclosure, as illustrated in FIGS. 1 to 3, it is unnecessary to provide a total of nine tabs 63.

The tabs 63a to 63i illustrated in FIGS. 1 to 3 exemplify, when the tab 63a is defined as the first protrusion portion, combinations of a configuration including only two of the first protrusion portion and the second protrusion portion. Examples of the second protrusion portion include at least one of the tab 63b that is adjacent to the tab 63a and advances and retreats in the same direction, the tab 63c that advances and retreats in the inclination direction from the left end with respect to the tab 63a, the tab 63e that advances and retreats in the inclination direction not sandwiching the support surface 61a from the rear end with respect to the tab 63a, the tab 63f that advances and retreats in the inclination direction sandwiching the support surface 61a from the rear end with respect to the tab 63a, the tab 63g that advances and retreats in the inclination direction from the facing right end with respect to the tab 63a, and the tab 63h or the tab 63i that advances and retreats from the facing right end with respect to the tab 63a. The same applies when any of the tabs 63b to 63i is used as a reference protrusion portion.

In the present embodiment, in the configuration including the first protrusion portion and the second protrusion portion, a protruding direction of the tab 63 may have a relation including the first direction Ds (left-right direction) or the second direction Df (front-rear direction) as a direction component. For example, the tab 63c and the tab 63d illustrated in FIG. 2 satisfy this relation. As another representative configuration, a configuration including three or more tabs 63 in total so as to surround the support surface 61a can be exemplified. Accordingly, a surface connecting the three or more tabs 63 to each other can be assumed, and thus the peripheral edge portion of the printing medium can be efficiently pressed.

In the present embodiment, the tab 63 is configured to be capable of advancing and retreating from the sub-platen 62, but the tab 63 may be fixed to the sub-platen 62. In this case, the amount of protrusion of the tab 63 or the shape of the sub-platen 62 may be appropriately set in accordance with the shape or dimension of the printing medium such that the protruding tab 63 does not reach the central portion of the printing medium.

In the present embodiment, the engagement portion such as the ball plunger 67 is provided in the sub-platen 62, but the engagement portion may be provided in the rear portion 632 of the tab 63. In this case, a plurality of engaged portions may be provided on a lower surface (inner surface) of the sub-platen 62 side by side in the advancing and retreating direction of the tab 63, and the engagement portion provided in the tab 63 may be configured to engage with any of the plurality of engaged portions provided in the sub-platen 62.

In the present embodiment, the hinge 64 that enables the sub-platen 62 to pivot is provided at the rear portion, but may be provided at either the left or right end portion. Similarly, in the present embodiment, the front end of the base platen 61 is inclined downward, but either the left or right end portion may be inclined. In addition, the base platen 61 and the sub-platen 62 are not limited to be coupled by the hinge 64, and may be coupled by the coupling portion. Examples of the coupling portion include a parallel bar. The parallel bar may be, for example, a mechanism that causes the sub-platen 62 to move in the up-down direction with respect to the base platen 61, such as a link mechanism provided at the rear portion of the base platen 61. Accordingly, the front end of the sub-platen 62 can be opened and closed with respect to the base platen 61.

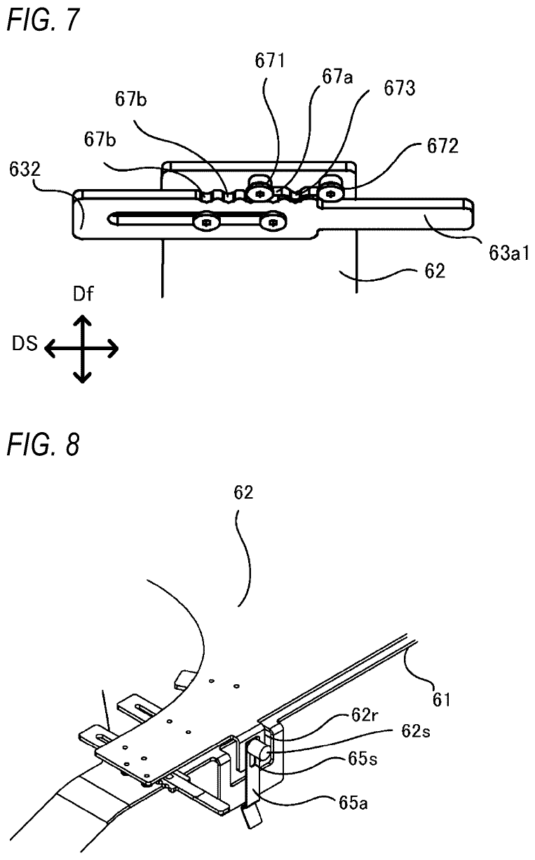

In the present embodiment, the ball plunger 67 is provided as an engagement portion, and the ball plunger slit 634 is provided as a non-engagement portion, but the present invention is not limited thereto. For example, as illustrated in FIG. 7, two pins 671 and 672 are provided on the sub-platen 62, and an engagement plate 67a fixed to the two pins 671 and 672 is provided. The engagement plate 67a includes an engagement portion 673 protruding toward a tab 63al. A plurality of concave portions 67b concaved in a direction away from the engagement plate 67a are provided in a rear portion 632 of the tab 63al in an advancing and retreating direction of the tab 63a1. The engagement plate 67a is elastically deformable in a direction away from the tab 63al, and when the engagement plate 67a moves in the advancing and retreating direction of the tab 63a1, the engagement portion 673 of the engagement plate 67a engages with one concave portion 67b, and the tab 63al can be positioned in the advancing and retreating direction. The concave portion 67b is an example of the engaged portion of the present disclosure.

In the present embodiment, the locker 65 that maintains the closed state of the sub-platen 62 is provided. The locker 65 may be provided with a mechanism for variably maintaining the interval between the base platen 61 and the sub-platen 62 in the up-down direction. Accordingly, the interval between the base platen 61 and the sub-platen 62 in the up-down direction can be changed according to a thickness of the printing medium in the up-down direction, and the closed state of the sub-platen 62 can be favorably maintained. For example, as illustrated in FIG. 8, a slit 65s long in the up-down direction is provided at an upper end of the hook 65a. A screw hole is provided in a right side plate 62r extending downward from a right end portion of the sub-platen 62. A screw 62s is provided so as to be inserted through the slit 65s and screwed into the screw hole. Since the slit 65s is long in the up-down direction, the hook 65a can move in the up-down direction in a state in which the screw 62s is loosened. Therefore, a position of the locker 65 in the up-down direction can be changed by tightening the screw 62s in a state in which a position of the hook 65a in the up-down direction is adjusted to a desired position. A guide pin extending in a right direction from the right side plate 62r may be inserted into the slit 65s.

Not limited to the screw 62s, a rotating plate with the left-right direction as an axis direction may be provided in the right side plate 62r. A concave portion concaved in a circumferential direction may be provided in the rotating plate, and may be engaged with a protruding pin protruding in the right direction from the frame body 65b. Since the concave portion is provided with steps having different distances to an axis, the interval between the base platen 61 and the sub-platen 62 in the up-down direction can be variably maintained. In addition, the protruding pin may be fixed at different positions in the up-down direction. Further, the rotating plate may rotate with the front-rear direction as an axis extending in.

As described above, the platen for an inkjet printer according to the present disclosure is a platen configured to support at least a part of a printing medium to be printed by an inkjet printer, the platen has a configuration including: a base platen that supports at least a part of the printing medium and has a surface extending in a first direction and a second direction orthogonal to the first direction; a sub-platen disposed on an upper portion of at least one of an end portion in the first direction and an end portion in the second direction of the surface; and a protrusion portion protruding from the sub-platen and configured to press the printing medium supported by the surface.

According to the above configuration, the protrusion portion configured to press the printing medium protrudes from the sub-platen disposed on the upper portion of at least one of the end portion in the first direction and the end portion in the second direction of the surface. Therefore, since a central portion of the printing medium supported on the surface is not pressed by the protrusion portion, a region where printing cannot be performed can be reduced.

In the platen for an inkjet printer having the above configuration, the protrusion portion may be configured to be capable of advancing and retreating with respect to the sub-platen along the surface.

According to the above configuration, since the protrusion portion is capable of advancing and retreating, even when the dimension of the printing medium is different, the printing medium can be pressed within a range of advancing and retreating movement. Accordingly, even a printing medium of a different dimension can be favorably supported.

In the platen for an inkjet printer having the above configuration, the protrusion portion may have a configuration including the first protrusion portion and the second protrusion portion.

According to the above configuration, since a plurality of the protrusion portions are included, the printing region can be more favorably supported.

In the platen for an inkjet printer having the above configuration, the first protrusion portion may protrude in the first direction, and the second protrusion portion may protrude in the second direction.

According to the above configuration, the protrusion occurs in each of the first direction and the second direction orthogonal to each other. Accordingly, the printing medium can be more favorably supported.

Since the first protrusion portion and the second protrusion portion can protrude in the first direction and the second direction, respectively, the range of the applicable size of the printing medium can be further widened.

In the platen for an inkjet printer having the above configuration, the plurality of the protrusion portions may be configured to be capable of advancing and retreating independently of each other.

According to the above configuration, even when the shape of the printing medium is different from the shape of the surface, the printing medium can be favorably pressed. Accordingly, the printing medium can be more stably supported.

In the platen for an inkjet printer having the above configuration, the engagement portion may be provided on any of the sub-platen and the protrusion portion, a plurality of engaged portions may be provided on the other of the sub-platen and the protrusion portion side by side in the advancing and retreating direction of the protrusion portion, and the engagement portion may engage with any of the engaged portions.

According to the above configuration, since the engagement portion engages with any of the plurality of engaged portions, the protrusion portion can protrude with high reproducibility. Accordingly, the printing medium can be more stably pressed.

In the platen for an inkjet printer having the above configuration, each dimension of the protrusion portion in the first direction and the second direction may be larger than the dimension thereof in the third direction orthogonal to the first direction and the second direction.

According to the above configuration, by making the dimension in the third direction smaller than the dimensions in the first direction and the second direction, the distance between the printing medium supported by the base platen and the nozzle surface can be reduced. Accordingly, printing quality can be improved.

In the platen for an inkjet printer having the above configuration, the sub-platen may be configured such that with respect to the base platen, the sub-platen is openable and closable at one end in the first direction or the second direction, and is coupled by a coupling portion at the other end.

According to the above configuration, since one end of the base platen in the first direction or the second direction is provided in the sub-platen so as to be opened and closed, it is possible to open the sub-platen when the printing medium is supported by the base platen, and to close the sub-platen after the printing medium is installed. Accordingly, the printing medium can be easily supported by the base platen.

The platen for an inkjet printer having the above configuration may further include the maintaining member that maintains an interval between the base platen and the sub-platen.

According to the above configuration, a predetermined interval can be maintained by the maintaining member between the sub-platen that can be opened and closed on the front side and the base platen. Accordingly, the printing medium supported by the base platen can be pressed by the protrusion portion that ensures the predetermined interval. Therefore, the printing medium can be favorably supported on the surface.

In the platen for an inkjet printer having the above configuration, a portion of the base platen that is the one end in the first direction or the second direction may be inclined downward.

According to the above configuration, when the one end of the base platen in the first direction or the second direction is inclined downward, the printing medium is less likely to interfere with the base platen, and the printing medium is easily installed on the surface of the base platen. In addition, when the printing medium is less likely to interfere, the printing medium is easily installed on the surface even when the sub-platen is not largely opened, and the workability is improved. Further, the possibility that the base platen interferes with the nozzle surface of the inkjet printer can be effectively avoided.

In the platen for an inkjet printer having the above configuration, the protrusion portion may include a front portion that is a portion that advances to the surface of the base platen, and a rear portion that is a portion opposite to the front portion and at least a portion of which is located between the base platen and the sub-platen, and the front portion may be located farther from the surface than the rear portion.

According to the above configuration, an interval for pressing the printing medium can be ensured in the front portion of the protrusion portion. Accordingly, the interval between the base platen and the sub-platen can be prevented from being increased. As a result, the distance between the printing medium supported by the base platen and the nozzle surface of the inkjet printer can also be prevented from being increased, and thus deterioration in printing quality can be favorably prevented.

The present disclosure is not limited to the above embodiment, various changes arc possible within the scope of claims, and embodiments obtained by combining technical means disclosed in the different embodiments and a plurality of variations as appropriate are also included in the technical scope of the present invention.

According to the above configuration, the protrusion configured to press the printing medium protrudes from the sub-platen disposed on the upper portion of at least one of the end portion in the first direction and the end portion in the second direction of the surface. Therefore, since a central portion of the printing medium supported on the surface is not pressed by the protrusion, a region where printing cannot be performed can be reduced.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A platen for an inkjet printer configured to support at least a part of a printing medium to be printed by an inkjet printer, the platen comprising:
a base platen configured to support at least a part of the printing medium and includes a surface extending in a first direction and a second direction orthogonal to the first direction;
a sub-platen disposed on an upper portion of at least one of an end portion in the first direction and an end portion in the second direction of the surface; and
a protrusion protruding from the sub-platen and configured to press the printing medium supported by the surface.

2. The platen for an inkjet printer according to claim 1, wherein
the protrusion is capable of advancing and retreating with respect to the sub-platen along the surface.

3. The platen for an inkjet printer according to claim 1, wherein
the protrusion includes a first protrusion and a second protrusion.

4. The platen for an inkjet printer according to claim 3, wherein
the first protrusion protrudes in the first direction, and the second protrusion protrudes in the second direction.

5. The platen for an inkjet printer according to claim 3, wherein
a plurality of the protrusions are capable of advancing and retreating independently of each other.

6. The platen for an inkjet printer according to claim 2, wherein
any of the sub-platen and the protrusion is provided with an engagement portion,
the other of the sub-platen and the protrusion is provided with a plurality of engaged portions side by side in an advancing and retreating direction of the protrusion,
and the engagement portion engages with any of the engaged portions.

7. The platen for an inkjet printer according to claim 3, wherein
each dimension of the protrusion in the first direction and the second direction is larger than a dimension thereof in a third direction orthogonal to the first direction and the second direction.

8. The platen for an inkjet printer according to claim 1, wherein
with respect to the base platen, the sub-platen is openable and closable at one end in the first direction or the second direction, and is coupled by a coupling portion at the other end.

9. The platen for an inkjet printer according to claim 8, further comprising:
a maintaining member configured to maintain an interval between the base platen and the sub-platen.

10. The platen for an inkjet printer according to claim 8, wherein
a portion of the base platen at one end in the first direction or the second direction is inclined downward.

11. The platen for an inkjet printer according to claim 1, wherein
the protrusion has a front portion that is a portion that advances to the surface of the base platen, and a rear portion that is a portion opposite to the front portion and at least a portion of which is located between the base platen and the sub-platen, and
the front portion is located farther from the surface than the rear portion.
